(19) United States
(12) Patent Application Publication
(10) Pub. No.: US 2005/0008865 A1
(43) Pub. Date: Jan. 13, 2005

(54) Curable epoxy compositions and articles made therefrom

(75) Inventors: Slawomir Rubinsztajn, Niskayuna, NY (US); Deborah Haitko, Schenectady, NY (US)

Correspondence Address: General Electric Company;CRD Patent Docket Rm 4A59, Bldg. K-1, P.O. Box 8, Schenectady, NY, 12301, US

(73) Assignee: General Electric Company

(21) Appl. No.: 10/613,955

(22) Filed: Jul. 7, 2003

(51) Int. Cl. B32B 27/38; C08L 63/00

(52) U.S. Cl. 428/413; 523/443

(57) ABSTRACT

A curable epoxy formulation comprising at least one epoxy monomer, at least one organofunctionalized colloidal silica, at least one alkyl onium cure catalyst, and optional reagents is provided in the present invention. Also disclosed are a packaged solid state device comprising an encapsulant comprising the aforementioned curable epoxy formulation.

### BACKGROUND OF THE INVENTION

This invention relates to epoxy resin compositions. More particularly, this invention relates to an epoxy resin compositions useful for solid state devices.

Solid state devices, sometimes referred to as semiconductor devices or opto-electronic devices, comprise light emitting diodes (LEDs), charge coupled devices (CCDs), large scale integrations (LSIs), photodiodes, vertical cavity surface emitting lasers (VCSELs), phototransistors, photocouplers, opto-electronic couplers and the like. Such devices often exhibit special packaging needs. High-efficiency, high lumen, solid-state white LEDs require a novel packaging material which can withstand more demanding conditions than those required by typical low-intensity, longer wavelength LEDs. Common packaging materials will often undergo a gradual loss of optical and mechanical properties due to the combination of thermal, oxidative and photodegradation processes.

There is thus a continuing need for novel packaging material for solid state devices, such packaging material desirably possessing properties such as high transparency, accelerated ultraviolet aging, low color, and low coefficient of thermal expansion.

### BRIEF SUMMARY OF THE INVENTION

The present invention provides a curable epoxy formulation comprising at least one epoxy monomer, at least one organofunctionalized colloidal silica, at least one alkyl onium cure catalyst, and optional reagents.

In another embodiment, the present invention provides a solid state device comprising an encapsulant,
wherein the encapsulant comprises at least one epoxy monomer, at least one organofunctionalized colloidal silica, at least one alkyl onium cure catalyst, and optional reagents.

### DETAILED DESCRIPTION OF THE INVENTION

It has been found that the use of at least one epoxy resin, at least one functionalized colloidal silica, at least one alkyl onium cure catalyst, and optional reagents provides a curable epoxy formulation whose cured parts have high transparency and a low coefficient of thermal expansion (CTE). “High transparency” as used herein refers to a cured total composition with at least about 80% optical transmission at 400 nanometers (nm). “Low coefficient of thermal expansion” as used herein refers to a cured total composition with a coefficient of thermal expansion lower than that of the base resin as measured in parts per million per degree centigrade (ppm/° C.). Typically, the coefficient of thermal expansion of the cured total composition is below about 70 ppm/° C. “Cured” as used herein refers to a total formulation with reactive groups wherein in a range between about 50% and about 100% of the reactive groups have reacted.

Epoxy resins are curable monomers and oligomers that can be blended with the functionalized colloidal silica. Epoxy resins include any organic system or inorganic system with an epoxy functionality. The epoxy resins useful in the present invention include those described in “Chemistry and Technology of the Epoxy Resins,” B. Ellis (Ed.) Chapman Hall 1993, New York and “Epoxy Resins Chemistry and Technology,” C. May and Y. Tanaka, Marcell Dekker 1972, New York. Epoxy resins that can be used for the present invention include those that could be produced by reaction of a hydroxyl, carboxyl or amine containing compound with epichlorohydrin, preferably in the presence of a basic catalyst, such as a metal hydroxide, for example sodium hydroxide. Also included are epoxy resins produced by reaction of a compound containing at least one and preferably two or more carbon-carbon double bonds with a peroxide, such as a peroxyacid.

Preferred epoxy resins for the present invention are cycloaliphatic and aliphatic epoxy resins. Aliphatic epoxy resins include compounds that contain at least one aliphatic group and at least one epoxy group. Examples of aliphatic epoxies include butadiene dioxide, dimethylpentane dioxide, diglycidyl ether, 1,4-butanedioldiglycidyl ether, diethylene glycol diglycidyl ether, and dipentene dioxide.

Cycloaliphatic epoxy resins are well known to the art and, as described herein, are compounds that contain at least about one cycloaliphatic group and at least one oxirane group. More preferred cycloalipahtic epoxies are compounds that contain about one cycloaliphatic group and at least two oxirane rings per molecule. Specific examples include 3-cyclohexenylmethyl-3-cyclohexenylcarboxylate diepoxide, 2-(3,4-epoxy)cyclohexyl-5,5-spiro-(3,4-epoxy)cyclohexane-m-dioxane, 3,4-epoxycyclohexylalkyl-3,4-epoxycyclohexanecarboxylate, 3,4-epoxy-6-methylcyclohexylmethyl-3,4-epoxy-6-methylcyclohexanecarboxylate, vinyl cyclohexanedioxide, bis(3,4-epoxycyclohexylmethyl)adipate, bis(3,4-epoxy-6-methylcyclohexylmethyl)adipate, exoexo bis(2,3-epoxycyclopentyl)ether, endo-exo bis(2,3 epoxycyclopentyl) ether, 2,2-bis(4-2,3-(poxypropoxy)cyclohexyl)propane, 2,6-bis(2,3-epoxypropoxycyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)hexahydro-4,7-methanoindane, p-(2,3-epoxy)cyclopentylphenyl-2,3-epoxypropylether, 1-(2,3-epoxypropoxy)phenyl-5,6-epoxyhexahydro-4,7-methanoindane, o-(2,3-epoxy)cyclopentylphenyl-2,3-epoxypropyl ether), 1,2-bis(5-(1,2-epoxy)-4,7-hexahydromethanoindanoxyl)ethane, cyclopentenylphenyl glycidyl ether, cyclohexanediol diglycidyl ether, and diglycidyl hexahydrophthalate. Typically, the cycloaliphatic epoxy resin is 3-cyclohexenylmethyl-3-cyclohexenylcarboxylate diepoxide.

Aromatic epoxy resins may also be used with the present invention. Examples of aromatic epoxy resins useful in the present invention include bisphenol-A epoxy resins, bisphenol-F epoxy resins, phenol novolac epoxy resins, cresol-novolac epoxy resins, biphenol epoxy resins, biphenyl epoxy resins, 4,4′-biphenyl epoxy resins, polyfunctional epoxy resins, divinylbenzene dioxide, and 2-glycidylphenylglycidyl ether. When resins, including aromatic, aliphatic and cycloaliphatic resins are described throughout the specification and claims, either the specifically-named resin or molecules having a moiety of the named resin are envisioned.

The present invention may also include silicone-epoxy resins having the formula:
MₐM′_{b}D_{c}D′_{d}TₑT′_{f}Q_{g}
where the subscripts a, b, c, d, e, f and g are zero or a positive integer, subject to the limitation that the sum of the subscripts b, d and f is one or greater; where M has the formula:
R¹₃SiO_{1/2},
M′ has the formula:
(Z)R²₂SiO_{1/2}
D has the formula:
R³₂SiO_{2/2}
D′ has the formula:
(Z)R⁴SiO_{2/2},
T has the formula:
R⁵SiO_{3/2},
T′ has the formula:
(Z)SiO_{3/2},
and Q has the formula SiO_{4/2}, where each R¹, R², R³, R⁴, R⁵ is independently at each occurrence a hydrogen atom, C₁₋₂₂ alkyl, C₁₋₂₂ alkoxy, C₂₋₂₂ alkenyl, C₆₋₁₄ aryl, C₆₋₂₂ alkyl-substituted aryl, or C₆₋₂₂ arylalkyl which groups may be halogenated, for example, fluorinated to contain fluorocarbons such as C₁₋₂₂ fluoroalkyl, or may contain amino groups to form aminoalkyls, for example aminopropyl or aminoethylaminopropyl, or may contain polyether units of the formula (CH₂CHR⁶O)ₖ where R⁶ is CH₃ or H and k is in a range between about 4 and 20; and Z, independently at each occurrence, represents organic radicals containing an epoxy group. The term “alkyl” as used in various embodiments of the present invention is intended to designate normal alkyl, branched alkyl, aralkyl, and cycloalkyl radicals. Normal and branched alkyl radicals are preferably those containing in a range between about 1 and about 12 carbon atoms, and include as illustrative non-limiting examples methyl, ethyl, propyl, isopropyl, butyl, tertiary-butyl, pentyl, neopentyl, and hexyl. Cycloalkyl radicals represented in the present invention are preferably those containing in a range between about 4 and about 12 ring carbon atoms. Some illustrative non-limiting examples of these cycloalkyl radicals include cyclobutyl, cyclopentyl, cyclohexyl, methylcyclohexyl, and cycloheptyl. Preferred aralkyl radicals are those containing in a range between about 7 and about 14 carbon atoms; these include, but are not limited to, benzyl, phenylbutyl, phenylpropyl, and phenylethyl. Aryl radicals used in the various embodiments of the present invention are preferably those containing in a range between about 6 and about 14 ring carbon atoms. Some illustrative non-limiting examples of these aryl radicals include phenyl, biphenyl, and naphthyl. An illustrative non-limiting example of a suitable halogenated moiety is trifluoropropyl. Combinations of epoxy monomers and oligomers may also be used in the present invention.

Colloidal silica is a dispersion of submicron-sized silica (SiO₂) particles in an aqueous or other solvent medium. The colloidal silica contains up to about 85 weight % of silicon dioxide (SiO₂) and typically up to about 80 weight % of silicon dioxide. The particle size of the colloidal silica is typically in a range between about 1 nanometer (nm) and about 250 nm, and more typically in a range between about 5 nm and about 150 nm. The colloidal silica is functionalized with an organoalkoxysilane to form (via infra) an organofunctionalized colloidal silica.

Organoalkoxysilanes used to functionalize the colloidal silica are included within the formula:
(R⁷)ₐSi(OR⁸)₄₋ₐ,
where R⁷ is independently at each occurrence a C₁₋₁₈ monovalent hydrocarbon radical optionally further functionalized with alkyl acrylate, alkyl methacrylate, epoxide groups, C₆₋₁₄ aryl radical, or alkyl radical; R⁸ is independently at each occurrence a C₁₋₁₈ monovalent hydrocarbon radical or a hydrogen radical; and “a” is a whole number equal to 1 to 3 inclusive. Preferably, the organoalkoxysilanes included in the present invention are 2-(3,4-epoxy cyclohexyl)ethyltrimethoxysilane, 3-glycidoxypropyltrimethoxysilane, phenyltrimethoxysilane, and methacryloxypropyltrimethoxysilane. A combination of functionality is possible. Typically, the organoalkoxysilane is present in a range between about 5 weight % and about 60 weight % based on the weight of silicon dioxide contained in the colloidal silica. The resulting organofunctionalized colloidal silica can be treated with an acid or base to neutralize the pH. An acid or base as well as other catalysts promoting condensation of silanol and alkoxysilane groups may also be used to aid the functionalization process. Such catalyst include organo-titane and organo-tin compounds such as tetrabutyl titanate, titanium isopropoxybis(acetylacetonate), dibutyltin dilaurate, or combinations thereof.

The functionalization of colloidal silica may be performed by adding the organoalkoxysilane functionalization agent to a commercially available aqueous dispersion of colloidal silica in the weight ratio described above to which an aliphatic alcohol has been added. The resulting composition comprising the functionalized colloidal silica and the organoalkoxysilane functionalization agent in the aliphatic alcohol is defined herein as a pre-dispersion. The pre-dispersion is transparent. “Transparent” as used herein refers to a maximum haze percentage of 15, typically a maximum haze percentage of 10; and most typically a maximum haze percentage of 3. The aliphatic alcohol may be selected from but not limited to isopropanol, t-butanol, 2-butanol, and combinations thereof. The amount of aliphatic alcohol is typically in a range between about 1 fold and about 10 fold of the amount of silicon dioxide present in the aqueous colloidal silica pre-dispersion. In some cases, stabilizers such as 4-hydroxy-2,2,6,6-tetramethylpiperidinyloxy (i.e. 4-hydroxy TEMPO) may be added to this transparent pre-dispersion. In some instances small amounts of acid or base may be added to adjust the pH of the transparent pre-dispersion. The resulting transparent pre-dispersion is typically heated in a range between about 50° C. and about 100° C. for a period of time in a range between about 1 hour and about 5 hours.

The cooled transparent organic pre-dispersion is then further treated to form a final dispersion of the functionalized colloidal silica by addition of curable epoxy monomers or oligomers and optionally, more aliphatic solvent which may be selected from but not limited to isopropanol, 1-methoxy-2-propanol, 1-methoxy-2-propyl acetate, toluene, and combinations thereof. This final dispersion of the functionalized colloidal silica may be treated with acid or base or with ion exchange resins to remove acidic or basic impurities. Exemplary acid, base, or ion exchange resins include but are not limited to crosslinked polyvinylpyridine, aminomethylated copolymers of polystyrene and divinylbenzene, and porous ion-exchange resins such as Amberlite® IRA-900 from Rohm and Haas or Dowex® MSA-1 from Dow Company.

In some instances, the pre-dispersion or the final dispersion of the functionalized colloidal silica may be further functionalized. Low boiling components are at least partially removed and subsequently, an appropriate capping agent that will react with residual hydroxyl functionality of the functionalized colloidal silica is added in an amount in a range between about 0.05 times and about 10 times the amount of silicon dioxide present in the pre-dispersion or final dispersion. Partial removal of low boiling components as used herein refers to removal of at least about 10% of the total amount of low boiling components, and preferably, at least about 50% of the total amount of low boiling components. An effective amount of capping agent caps the functionalized colloidal silica. Capped functionalized colloidal silica is defined herein as a functionalized colloidal silica in which at least 10%, preferably at least 20%, more preferably at least 35%, of the free hydroxyl groups present in the corresponding uncapped functionalized colloidal silica have been functionalized by reaction with a capping agent. Capping the functionalized colloidal silica effectively improves the cure of the total curable epoxy formulation by improving room temperature stability of the epoxy formulation. Formulations which include the capped functionalized colloidal silica show much better room temperature stability than analogous formulations in which the colloidal silica has not been capped. If the pre-dispersion was reacted with the capping agent, at least one curable epoxy monomer is added to form the final dispersion.

Exemplary capping agents include hydroxyl reactive materials such as silylating agents. Examples of a silylating agent include, but are not limited to hexamethyldisilazane (HMDZ), tetramethyldisilazane, divinyltetrametyldisilazane, diphenyltetramethyldisilazane, N-(trimethylsilyl)diethylamine, 1-(trimethylsilyl)imidazole, trimethylchlorosilane, pentamethylchlorodisiloxane, pentamethyldisiloxane, and combinations thereof.

The capped or uncapped final dispersion of the functionalized colloidal silica is concentrated under a vacuum in a range between about 0.5 Torr and about 250 Torr at a temperature in a range between about 20° C. and about 140° C. for a period of time in a range between about 0.5 hours and about 48 hours to substantially remove any low boiling components such as solvent, residual water, and combinations thereof to give a transparent dispersion of functionalized colloidal silica in a curable epoxy monomer, herein referred to as a “final concentrated dispersion”. Substantial removal of low boiling components is defined herein as removal of at least about 90% of the total amount of low boiling components.

In order to form the total curable epoxy formulation, the alkyl onium cure catalyst is added to the final concentrated dispersion. Cure catalysts accelerate curing of the total curable epoxy formulation. Typically, the catalyst is present in a range between about 10 parts per million (ppm) and about 10% by weight of the total curable epoxy formulation. Examples of alkyl onium cure catalysts include, but are not limited to bisaryliodonium salts (e.g. bis(dodecylphenyl)iodonium hexafluoroantimonate, (octyloxyphenyl, phenyl)iodonium hexafluoroantimonate, bisaryliodonium tetrakis(pentafluorophenyl)borate), triarylsulphonium hexafluoroantimonate, and combinations thereof. Preferably, the catalyst is an alkyl sulfonium catalyst such as 3-methyl-2-butenyltetramethylene sulfonium hexafluoroantimonate or a substituted aryl-dialkyl sulfonium hexafluoroantimonate, and more preferably, 3-methyl-2-butenyltetramethylene sulfonium hexafluoroantimonate. Optionally, an effective amount of a free-radical generating compound can be added as the optional reagent such as aromatic pinacols, benzoinalkyl ethers, organic peroxides, and combinations thereof. The free radical generating compound facilitates decomposition of onium salt at lower temperatures than if the free-radical generating compound was not present.

A reactive organic diluant may also be added to the total curable epoxy formulation to decrease the viscosity of the composition. Examples of reactive diluants include, but are not limited to, 3-ethyl-3-hydroxymethyl-oxetane, dodecylglycidyl ether, 4-vinyl-1-cyclohexane diepoxide, di(Beta-(3,4-epoxycyclohexyl)ethyl)-tetramethyldisiloxane, and combinations thereof. An unreactive diluant may also be added to the composition to decrease the viscosity of the formulation. Examples of unreactive diluants include, but are not limited to toluene, ethylacetate, butyl acetate, 1-methoxy propyl acetate, ethylene glycol, dimethyl ether, and combinations thereof.

An effective amount of adhesion promoters may also be employed with the total curable epoxy formulation such as trialkoxyorganosilanes (e.g. γ-aminopropyltrimethoxysilane, 3-glycidoxypropyltrimethoxysilane, bis(trimethoxysilylpropyl)fumarate), and combinations thereof. An effective amount of adhesion promoter is typically in a range between about 0.01% by weight and about 2% by weight of the total curable epoxy formulation.

Flame retardants may optionally be used in the total curable epoxy formulation of the present invention in a range between about 0.5 weight % and about 20 weight % relative to the amount of the total curable epoxy formulation. Examples of flame retardants in the present invention include phosphoramides, triphenyl phosphate (TPP), resorcinol diphosphate (RDP), bisphenol-a-disphosphate (BPA-DP), organic phosphine oxides, halogenated epoxy resin (tetrabromobisphenol A), metal oxide, metal hydroxides, and combinations thereof.

Additional optional reagents may include, but are not limited to, standard anti-oxidants, mold releasing additives, plasticizing additives, or combinations thereof.

The composition of the present invention may by hand mixed but also can be mixed by standard mixing equipment such as dough mixers, chain can mixers, planetary mixers, twin screw extruder, two or three roll mill, and the like. The blending of the present invention can be performed in batch, continuous, or semi-continuous mode.

The composition used to form the solid state device application is typically poured or injected into a mold form in a manner optimizing environmental conditions such as temperature, atmosphere, voltage and pressure, to minimize voids, stresses, shrinkage and other potential defects. Typically, the process step of molding the encapsulant is performed in a vacuum, preferably at a processing temperature that does not exceed about 250° C. Typically, the composition cures during molding. Curing typically occurs at a temperature in a range between about 70° C. and about 110° C., and more typically in a range between about 80° C. and about 90° C., at a pressure in a range between about 1 atmosphere (atm) and about 5 tons pressure per square inch, and more typically in a range between about 1 atmosphere and about 1000 pounds per square inch (psi). In addition, curing may typically occur over a period of time in a range between about 30 seconds and about 5 hours, and more typically in a range between about 90 seconds and about 30 minutes for initial cure and typically in a range between about 2 hours and about 4 hours at 130° C. for final curing.

The epoxy resin compositions of the present invention can be used in applications known for epoxy resin compositions. Such applications comprise coatings, potting compounds, and encapsulants for solid-state devices. In one embodiment, a solid-state device is a light emitting diode (LED). The light emitting diode, for example, may be packaged with an encapsulant of the present invention. In another embodiment of the present invention, the encapsulating composition may be used with a vertical cavity surface emitting laser (VCSEL).

In order that those skilled in the art will be better able to practice the present invention, the following examples are given by way of illustration and not by way of limitation.

### EXAMPLES

The following section provides experimental details on the preparation of the functionalized colloidal silica samples as well as properties of epoxy formulations that incorporate these materials. The data in the following tables substantiate the assertion that an advantageous combination of reduction of Coefficient of Thermal Expansion (CTE) and preservation of material transparency can be obtained with the use of the onium cure catalyst.

1. Preparation of Functionalized Colloidal Silica Pre-Dispersion

Functionalized colloidal silica pre-dispersion was prepared using the following procedure. A mixture of aqueous colloidal silica (465 grams (g); 34% silica, Nalco 1034a), isopropanol (800 g) and phenyltrimethoxy silane (56.5 g) was heated and stirred at 60-70° C. for 2 hours to give a clear suspension. The resulting mixture was cool down to room temperature and stored in a glass bottle.

Preparation of Stabilized Functionalized Colloidal Silica Dispersions

A 250-milliliter (ml) flask was charged with 50 g of the colloidal silica pre-dispersion, 50 g of 1-methoxy-2-propanol (Aldrich) and 0.5 g of crosslinked polyvinylpyridine. The mixture was stirred at 70° C. After 1 hour the suspension was blended with 50 g of 1-methoxy-2-propanol and 2 g Celite® 545, cooled down to the room temperature and filtered. The resulting dispersion of functionalized colloidal silica was blended with 10 g of UVR6105 (3,4-Epoxycyclohexylmethyl-3,4-epoxycyclohexanecarboxylate from Dow Chemical Company) and vacuum stripped at 75° C. at 1 mmHg to the constant weight to yield 17.6 g of a liquid resin with a viscosity of 2240 milliPascal·second (mPa·s).

Preparation of the Curable Epoxy Formulation

The functionalized colloidal silica dispersions were blended at room temperature with 0.01-0.05 wt % of the thermally curing catalyst, 3-methyl-2-butenyltetramethylene sulfonium hexafluoroantimonate. The catalyst and formulation were blended at room temperature for approximately one—half hour after which time the formulation was degassed at room temperature for 20 minutes. Cure of the transparent and clear blended composition in disk form was accomplished in two stages, first curing at 30 minutes at 90° C. for approximately one—half hour and then final cure was achieved after a 2 hour cure was performed at 130° C. The molded disk was exposed to UV flux from an argon laser at 406 nanometers (nm) at approximately 300 milliwatts for 24 hours. The decrease in transmission was less than 2% versus initial measurements.

Exposing functionalized silica containing epoxies to an ultraviolet (UV) flux greater than 0-10 times that emitted from UV or blue LEDs showed that functionalized material of the present invention (i.e. silica epoxy) exhibited greater than 10% improvement of optical transmission versus typical LED encapsulants such as cycloolefin polymers and copolymers. Optical transmission was measured by utilizing a Macbeth Spectrophotometer. Results of the optical transmission improvement can be seen in Table 1.

TABLE 1

| | % optical transmission loss at 400 |
|---|---|
| Material | nanometers |
| Silica Epoxy | 5 |
| Cycloolefin copolymer | 12 |
| Bisphenol A Epoxy | 31 |

While embodiments have been shown and described, various modifications and substitutions may be made thereto without departing from the spirit and the scope of the invention. Accordingly, it is to be understood that the present invention has been described by way of illustration and not limitation.

1. A curable epoxy formulation comprising at least one epoxy monomer, at least one organofunctionalized colloidal silica, at least one alkyl onium cure catalyst, and optional reagents.

2. The curable epoxy formulation in accordance with claim 1, wherein the organofunctional colloidal silica comprises up to about 80 weight % of silicon dioxide, based on the total weight of the total curable epoxy formulation.

3. The curable epoxy formulation in accordance with claim 1, wherein the colloidal silica is functionalized with an organoalkoxysilane.

4. The curable epoxy formulation in accordance with claim 3, wherein the organoalkoxysilane comprises phenyltrimethoxysilane.

5. The curable epoxy formulation in accordance with claim 3, wherein the colloidal silica is further treated with an acid, basic, or ion exchange resin.

6. The curable epoxy formulation in accordance with claim 5, wherein the colloidal silica is treated with a basic resin.

7. The curable epoxy formulation in accordance with claim 6, wherein the basic resin comprises crosslinked polyvinylpyridine.

8. The curable epoxy formulation in accordance with claim 1, further comprising at least one organic diluant.

9. The curable epoxy formulation in accordance with claim 8, wherein the organic diluant comprises 3-ethyl-3-hydroxymethyl-oxetane.

10. The curable epoxy formulation in accordance with claim 1, wherein the epoxy monomer comprises a cycloaliphatic epoxy monomer, an aliphatic epoxy monomer, an aromatic epoxy monomer, a silicone epoxy monomer, or combinations thereof.

11. The curable epoxy formulation in accordance with claim 1, wherein the alkyl onium cure catalyst comprises an alkyl sulfonium cure catalyst.

12. The curable epoxy formulation in accordance with claim 11, wherein the alkyl sulfonium cure catalyst comprises 3-methyl-2-butenyltetramethylene sulfonium hexafluoroantimonate, substituted aryl-dialkyl sulfonium hexafluoroantimonate, or combinations thereof.

13. The curable epoxy formulation in accordance with claim 12, wherein the alkyl sulfonium cure catalyst comprises 3-methyl-2-butenyltetramethylene sulfonium hexafluoroantimonate.

14. The curable epoxy formulation in accordance with claim 1, wherein the cured formulation provides a coefficient of thermal expansion of below about 70 ppm/° C.

15. The curable epoxy formulation in accordance with claim 1, wherein the optional reagents comprise anti-oxidants, mold releasing additives, plasticizing additives, or combinations thereof.

16. The curable epoxy formulation in accordance with claim 1, wherein the cured formulation provides an optical transmission of at least about 80% at 400 nanometers.

17. A curable epoxy formulation comprising at least one epoxy monomer, phenyltrimethoxysilane functionalized colloidal silica, and a cure catalyst comprising 3-methyl-2-butenyltetramethylene sulfonium hexafluoroantimonate.

18. A solid state device comprising an encapsulant,
wherein the encapsulant comprises at least one epoxy monomer, at least one organofunctionalized colloidal silica, at least one alkyl onium cure catalyst, and optional reagents.

19. The solid state device in accordance with claim 18, wherein the organofunctional colloidal silica comprises up to about 80 weight % of silicon dioxide, based on the total weight of the total curable epoxy formulation.

20. The solid state device in accordance with claim 18, wherein the colloidal silica is functionalized with an organoalkoxysilane.

21. The solid state device in accordance with claim 20, wherein the organoalkoxysilane comprises phenyltrimethoxysilane.

22. The solid state device in accordance with claim 20, wherein the colloidal silica is further treated with an acid, basic, or ion exchange resin.

23. The solid state device in accordance with claim 22, wherein the colloidal silica is further treated with a basic resin.

24. The solid state device in accordance with claim 22, wherein the basic comprises crosslinked polyvinylpyridine.

25. The solid state device in accordance with claim 18, wherein the encapsulant further comprises at least one organic diluant.

26. The solid state device in accordance with claim 25, wherein the organic diluant comprises 3-ethyl-3-hydroxymethyl-oxetane.

27. The solid state device in accordance with claim 18, wherein the epoxy monomer comprises a cycloaliphatic epoxy monomer, an aliphatic epoxy monomer, an aromatic epoxy monomer, a silicone epoxy monomer, or combinations thereof.

28. The solid state device in accordance with claim 18, wherein the alkyl onium cure catalyst comprises alkyl sulfonium cure catalyst.

29. The solid state device in accordance with claim 28, wherein the alkyl sulfonium cure catalyst comprise 3-methyl-2-butenyltetramethylene sulfonium hexafluoroantimonate, substituted aryl-dialkyl sulfonium hexafluoroantimonate, or combinations thereof

30. The solid state device in accordance with claim 29, wherein the alkyl onium cure catalyst comprises 3-methyl-2-butenyltetramethylene sulfonium hexafluoroantimonate.

31. The solid state device in accordance with claim 18, wherein the cured encapsulant provides a coefficient of thermal expansion of below about 70 ppm/° C.

32. The solid state device in accordance with claim 18, wherein the optional reagent comprises anti-oxidants, mold releasing additives, plasticizing additives, or combinations thereof.

33. The solid state device in accordance with claim 18, wherein the encapsulant provides an optical transmission of at least about 80% at 400 nanometers.

34. A light emitting diode comprising an encapsulant,
wherein the encapsulant comprises at least one epoxy monomer, phenyltrimethoxysilane functionalized colloidal silica, and a cure catalyst comprising 3-methyl-2-butenyltetramethylene sulfonium hexafluoroantimonate
